(19) United States
(12) Patent Application Publication
(10) Pub. No.: US 2022/0159022 A1
(43) Pub. Date: May 19, 2022

(54) DETECTING ANOMALOUS TRAFFIC

(71) Applicant: Branch Metrics, Inc., Redwood City, CA (US)

(72) Inventors: Behdad Aghamirzaei, Sunnyvale, CA (US); Thomas Stevenson, Bainbridge Island, WA (US); Bo-hyung Son, Seoul (KR)

(73) Assignee: Branch Metrics, Inc., Redwood City, CA (US)

(21) Appl. No.: 17/528,517

(22) Filed: Nov. 17, 2021

Related U.S. Application Data
(60) Provisional application No. 63/115,095, filed on Nov. 18, 2020.

(51) Int. Cl. H04L 29/06; G06Q 30/02

(52) U.S. Cl. CPC H04L 63/1425; G06Q 30/0248

(57) ABSTRACT

A method includes acquiring first aggregate event data for a first sub-publisher. The first aggregate event data indicates aggregate user activity across a plurality of applications associated with the first sub-publisher. The method further includes acquiring second aggregate event data for a plurality of additional sub-publishers. The method further includes determining a plurality of anomaly metric values for the first sub-publisher based on the first aggregate event data and the second aggregate event data. The method further includes determining an anomaly function value for the first sub-publisher based on the anomaly metric values for the first sub-publisher. The anomaly function value indicates a likelihood that the first sub-publisher is associated with fraudulent user activity. The method further includes determining whether the user activity across the plurality of applications associated with the first sub-publisher is fraudulent based on the anomaly function value and notifying a customer device of fraudulent activity.

### CROSS-REFERENCE TO RELATED APPLICATIONS

This application claims the benefit of U.S. Provisional Application No. 63/115,095, filed on Nov. 18, 2020. The disclosure of the above application is incorporated herein by reference in its entirety.

### FIELD

The present disclosure relates to detecting anomalies associated with website and application traffic.

### BACKGROUND

Software developers can develop websites and applications that are accessed by users on a variety of different platforms, such as different computing devices and operating systems. Advertisers, such as application developers and other business entities, may advertise their applications, services, and other products across the variety of different computing platforms. Various parties (e.g., advertisers, developers, and others) may acquire analytics regarding the performance of their advertisements and websites/applications so that they can gain a better understanding of how their advertisements and websites/applications are consumed by users on different platforms. The various parties may also acquire analytics regarding performance in order to determine proper compensation associated with user consumption of advertisements and content on the different platforms.

### SUMMARY

In one example, the present disclosure is directed to a method comprising acquiring, at a computing device, first aggregate event data for a first sub-publisher, wherein the first aggregate event data indicates aggregate user activity across a plurality of applications associated with the first sub-publisher. The method further comprises acquiring second aggregate event data for a plurality of additional sub-publishers, wherein the second aggregate event data indicates aggregate user activity across a plurality of applications associated with the plurality of additional sub-publishers. The method further comprises determining a plurality of anomaly metric values for the first sub-publisher based on the first aggregate event data and the second aggregate event data. The method further comprises determining an anomaly function value for the first sub-publisher based on the anomaly metric values for the first sub-publisher, wherein the anomaly function value indicates a likelihood that the first sub-publisher is associated with fraudulent user activity. The method further comprises determining whether the user activity across the plurality of applications associated with the first sub-publisher is fraudulent based on the anomaly function value. The method further comprises notifying a customer device of fraudulent activity in response to determining that the user activity associated with the first sub-publisher is fraudulent.

In one example, the present disclosure is directed to a system comprising one or more storage devices and one or more processing units. The one or more storage devices are configured to store first aggregate event data for a first sub-publisher, wherein the first aggregate event data indicates aggregate user activity across a plurality of applications associated with the first sub-publisher. The one or more storage devices are configured to store second aggregate event data for a plurality of additional sub-publishers, wherein the second aggregate event data indicates aggregate user activity across a plurality of applications associated with the plurality of additional sub-publishers. The one or more processing units are configured to execute computer-readable instructions that cause the one or more processing units to determine a plurality of anomaly metric values for the first sub-publisher based on the first aggregate event data and the second aggregate event data. The one or more processing units are further configured to determine an anomaly function value for the first sub-publisher based on the anomaly metric values for the first sub-publisher, wherein the anomaly function value indicates a likelihood that the first sub-publisher is associated with fraudulent user activity. The one or more processing units are further configured to determine whether the user activity across the plurality of applications associated with the first sub-publisher is fraudulent based on the anomaly function value. The one or more processing units are further configured to notify a customer device of fraudulent activity in response to determining that the user activity associated with the first sub-publisher is fraudulent.

### BRIEF DESCRIPTION OF THE DRAWINGS

The present disclosure will become more fully understood from the detailed description and the accompanying drawings.

FIG. 1 illustrates an environment that includes an anomaly detection system that may detect anomalies associated with website and application traffic.

FIG. 2 is an example method that describes operation of the environment of FIG. 1.

FIG. 3 is an example functional block diagram that illustrates the generation of advertisements, delivery of advertisements to user devices, and the acquisition of event data by an event system.

FIGS. 4A-4B illustrate an example anomaly detection system that receives event data from the event system.

FIG. 5 shows an example chart for a single application (App ID 123) on an ad network (a_test) for a single sub-publisher (abcd). The chart includes a plurality of anomaly metric values and expected ranges.

FIG. 6A illustrates an example event system that may store a plurality of events for each user as user data objects.

FIG. 6B illustrates an example user data object.

FIG. 7A illustrates an example revenue leading digit distribution for a commerce application for a plurality of ad partners or sub-publishers.

FIG. 7B illustrates an example distribution of first digit revenue that does not follow Benford's law, but does illustrate a deviation from typical distributions that may be due to anomalous activity.

FIG. 8 illustrates an example spreadsheet report that includes rows for ad networks and associated sub-publishers. The report also includes shading that indicates values that may be associated with anomalous activity.

In the drawings, reference numbers may be reused to identify similar and/or identical elements.

### DETAILED DESCRIPTION

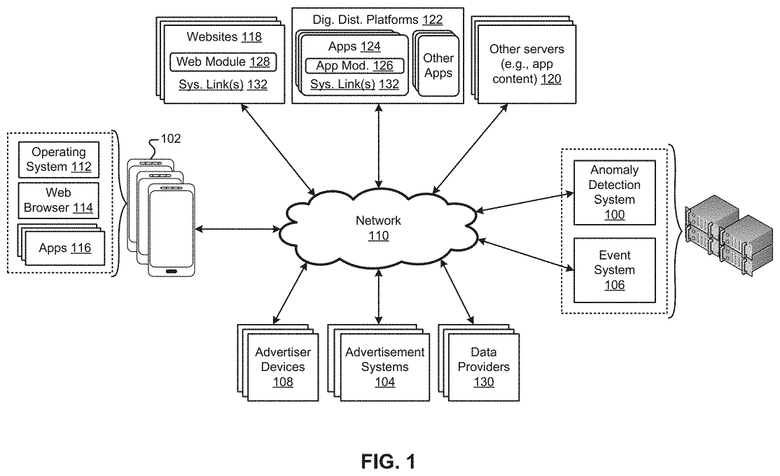

FIG. 1 illustrates an environment that includes an anomaly detection system 100 (hereinafter “detection system 100”) that may detect anomalies associated with website and application traffic. For example, the detection system 100 may detect anomalies associated with website/application usage, advertisement selection, and application installations. In some implementations, the detection system 100 may detect anomalies associated with application/website traffic from a single device (e.g., user device 102). In some implementations, the detection system 100 may detect anomalies associated with application/website traffic from a plurality of users (e.g., user devices 102) or other computing devices that are not legitimate user devices (e.g., emulators).

Anomalies may refer to unexpected/abnormal traffic patterns for one or more devices. In one example, anomalies may include fraudulent behavior, such as deceptive traffic that is perpetrated for financial gain or other reasons. In another example, anomalies may include low quality traffic, such as advertisements that do not perform because of one or more factors (e.g., poor placement/execution), which may also include fraud.

The detection system 100 may detect anomalies for a variety of different entities (e.g., business entities), such as advertisers (e.g., app developers and/or advertising agencies), advertising networks, and sub-publishers. In some implementations, the detection system 100 may detect anomalies in an advertisement context. For example, the detection system 100 may detect anomalies (e.g., fraud) associated with one or more entities (e.g., ad networks and/or sub-publishers) that provide advertisements to users. In some examples, the detection system 100 may detect anomalies in website/application advertisement selections and/or subsequent application installations and application/web usage associated with the advertisement selections.

In a specific example, the detection system 100 may detect anomalies associated with advertisement systems 104 (i.e., advertising networks) and/or sub-publisher traffic. For example, the detection system 100 may detect anomalies associated with sub-publishers. Although the detection of anomalies in advertisement systems 104 and sub-publishers in an advertising context is described herein, the detection system 100 may detect anomalies in other contexts, such as in different advertising contexts or other scenarios.

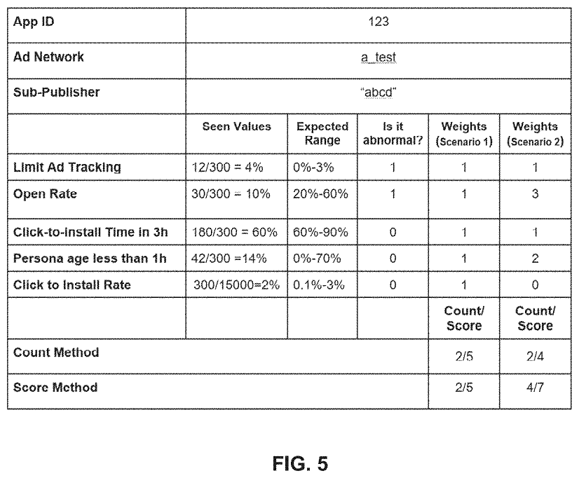

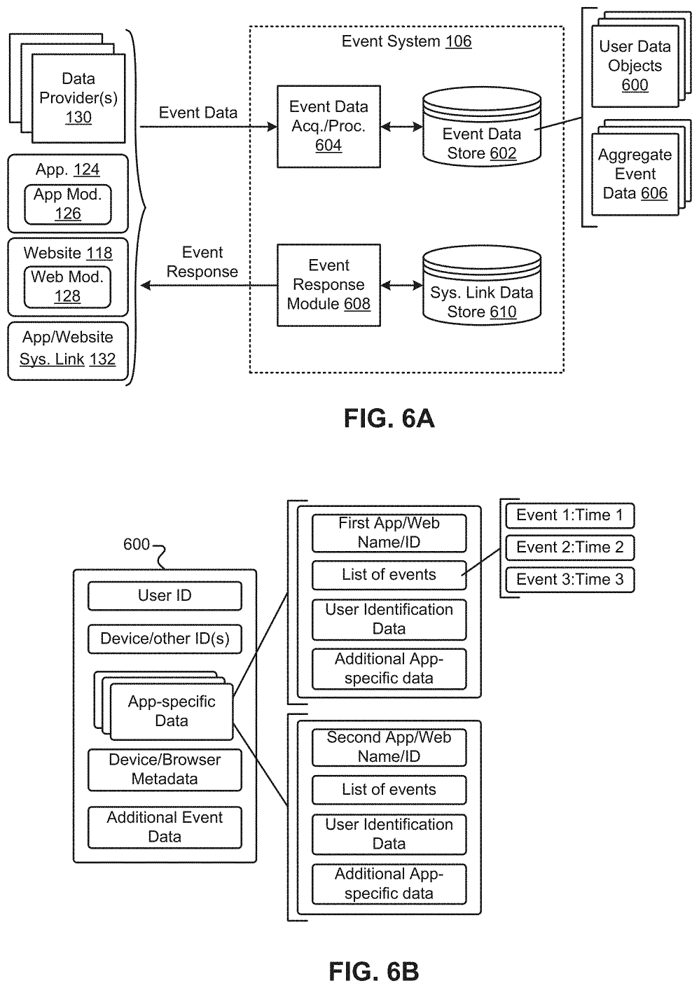

The environment includes an event system 106 that acquires event data that indicates how users use applications and/or websites. Event data described herein may include user device events that indicate a user's actions in an application or website. Example events described herein may include application events (e.g., events in applications) and web events (e.g., events on websites). The events may be reported by user devices 102 and/or other servers in real time or in batches. The event system 106 may store event data on a per-user basis and in the aggregate (e.g., see FIGS. 6A-6B). The detection system 100 may use the event data to identify anomalous traffic associated with sub-publishers.

The detection system 100 may use a plurality of anomaly metric types to determine whether an entity (e.g., sub-publisher) is associated with anomalous traffic (e.g., fraudulent traffic). In some implementations, the anomaly metric types may include metrics associated with individual device behaviors. In some implementations, the anomaly metric types may include metrics based on aggregate website traffic and application installation/usage associated with a sub-publisher. Example anomaly metrics may include, but are not limited to, device parameter anomaly metrics, downstream anomaly metrics, installation anomaly metrics, user data object metrics, internet protocol metrics, custom metrics, and other metrics described herein. In some implementations, the metrics may be app-specific (e.g., calculated on a per-app basis). The anomaly metrics may also be aggregated based on other factors, such as device type (e.g., mobile phone, tablet, laptop), device brand name, device model, device specifications (e.g., screen size, resolution, etc.), and operating system. The anomaly metrics may also be aggregated based on location (e.g., country, state, city, GPS), language, campaign, channel, placement (e.g., sub-site or sub-placement), and keyword. In some implementations, customers may generate new aggregations as custom metrics.

The detection system 100 may calculate anomaly metric values for the anomaly metrics. An anomaly metric value may indicate whether a sub-publisher is associated with anomalous activity (e.g., fraudulent activity). The detection system 100 may calculate a plurality of anomaly metric values for each sub-publisher. In some implementations, the detection system 100 may calculate anomaly metric values on a per-application basis for each sub-publisher.

The detection system 100 may identify sub-publisher traffic as anomalous traffic based on one or more of the anomaly metrics associated with the sub-publisher. For example, the detection system 100 may use the plurality of anomaly metrics to determine whether a sub-publisher is associated with anomalous traffic. In one example, the detection system 100 may implement an anomaly detection function that determines whether a sub-publisher is associated with anomalous traffic. The anomaly detection function may be a function of a plurality of anomaly metrics. The anomaly detection function may determine an anomaly function value for a sub-publisher based on a plurality of anomaly metric values. The anomaly function value may indicate a likelihood (e.g., a decimal value) that the sub-publisher is associated with anomalous traffic. In some implementations, the anomaly function value may be a binary value that indicates whether the sub-publisher is associated with anomalous traffic (e.g., 0/1 for normal/anomalous traffic).

The detection system 100 may provide one or more responses to identified anomalous activity. For example, the detection system 100 may flag the sub-publisher and/or sub-publisher activity as anomalous activity. The detection system 100 may provide data for the one or more responses to a customer (e.g., advertiser, developer, or other party). For example, the detection system 100 may notify the customer of the one or more flagged sub-publishers, along with the anomaly metric values and the anomaly function value upon which the flagged data is based. In some implementations, the detection system 100 may annotate (e.g., flag) event data associated with the anomalous traffic.

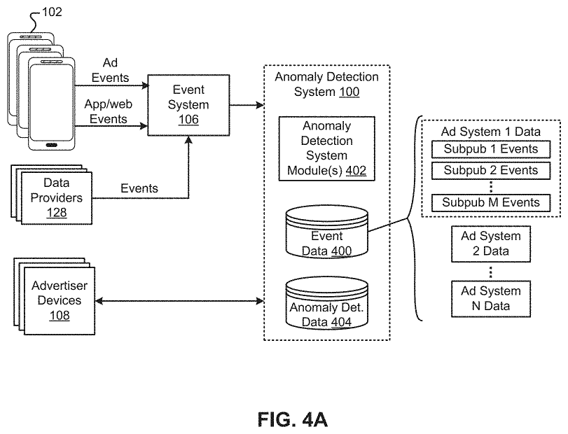

The detection system 100 may provide a customer interface to the customer (e.g., customer devices of FIG. 4B), such as a web-based and/or application-based interface. The customer can use the customer interface (e.g., dashboard) to view any of the data described herein. For example, the customer may view event data (e.g., flagged event data), anomaly metrics, anomaly functions, and anomaly function values. In some implementations, the customer may configure operation of the detection system parameters. For example, the customer may configure thresholds for determining whether anomaly metrics and anomaly function values should be flagged as indicating anomalous behavior. As another example, the customer may use the customer interface to configure the anomaly functions, such as which anomaly metrics are used, weighting of each anomaly metric, and other anomaly detection parameters.

The detection system 100 of the present disclosure may detect anomalies (e.g., fraud) in web/application traffic in a variety of ways. For example, the detection system 100 may detect anomalies at the device level and at an aggregate level, such as an aggregate level of traffic associated with a sub-publisher over time. In some cases, the detection system 100 may determine whether anomaly metrics should be flagged based on comparisons of metric values across a plurality of sub-publishers. For example, an anomaly metric may be flagged for a sub-publisher when the anomaly metric value is outside of the range of other trusted sub-publishers. Detecting anomalies (e.g., fraud) using anomaly metrics that take into account aggregate data over time across multiple sub-publishers may provide the ability to detect advanced forms of anomalous traffic at a sub-publisher level. Additionally, the detection system 100 may provide for accurate anomaly detection by taking into account multiple anomaly metrics with varying weightings according to the relative importance of the metrics.

The detection and flagging of anomalies, such as fraud, may be used by a variety of parties to prevent and manage fraudulent activity. For example, advertisers and advertising networks may use the detection system 100 to determine which business entities to use for advertisements. Advertisers and advertisement systems 104 may also manage traffic associated with fraudulent activity, such as compensation arrangements that are based on fraudulent events (e.g., incorrect attributions of installs/purchases to advertisements). For example, determinations of whether attributions are correct may provide the advertisers and advertising networks with information indicating whether they should pay for advertisement placements and/or whether to block some attributions/payments.

In some implementations, the detection system 100 and the event system 106 may be owned/operated by the same party (e.g., business). For example, functionality provided by the detection system 100 and the event system 106 described herein may be provided by a computing system operated by a single party. Alternatively, different parties may own/operate the systems 100, 106 of FIG. 1. Although the detection system 100 is described herein as identifying anomalous traffic associated with sub-publishers, the detection system 100 may be used to identify anomalous traffic associated with any group of users, devices, and events.

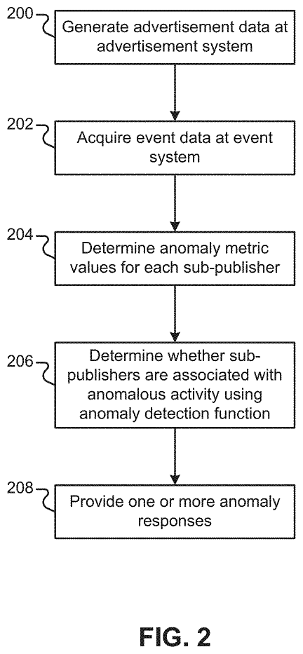

FIG. 2 is an example method that describes operation of the environment of FIG. 1. Initially, in block 200, the advertisers (e.g., advertiser computing devices 108) may generate advertisement data in the advertisement systems 104. The advertisement systems 104 may generate advertisements for the users in applications and/or on websites. In block 202, the event system 106 may acquire event data from user devices 102 and other sources (e.g., servers). The event data may indicate how the users are using websites and applications. The event data may also indicate advertisement views and selections.

In block 204, the detection system 100 acquires event data from the event system 106 and determines anomaly metric values for each of the sub-publishers. In block 206, the detection system 100 determines whether sub-publishers are associated with anomalous activity based on the determined anomaly metric values. For example, the detection system 100 may use an anomaly detection function that generates an anomaly function value indicating whether a sub-publisher is associated with anomalous activity. In block 208, the detection system 100 provides one or more anomaly responses based on whether sub-publishers are associated with anomalous activity.

Referring to FIG. 1, the environment includes a plurality of user devices 102, a detection system 100 (e.g., a server computing device), an event system 106 (e.g., a server computing device), advertiser devices 108, and advertisement systems 104 (e.g., advertising networks) in communication via a network 110. The network 110 may include various types of computer networks, such as a local area network (LAN), wide area network (WAN), and/or the Internet.

The user devices 102 may include, but are not limited to, smart phones, wearable computing devices (e.g., watches), tablet computers, laptop computers, desktop computers, and additional computing device form factors. A user device 102 may include an operating system 112 and a plurality of applications, such as a web browser application 114 and additional applications 116. Example additional applications may include, but are not limited to, search applications, e-commerce applications, social media applications, business review applications, banking applications, gaming applications, and weather forecast applications. Using the web browser 114, the user device 102 can access various websites 118 via the network 110. The user devices 102 may also access other servers 120, such as servers that provide application content.

The environment includes one or more digital distribution platforms 122. The digital distribution platforms 122 may represent computing systems that are configured to distribute applications 124 to user devices 102. Example digital distribution platforms 122 include, but are not limited to, the GOOGLE PLAY® digital distribution platform by Google LLC and the APP STORE® digital distribution platform by Apple, Inc. Users may download applications from the digital distribution platforms 122 and install the applications on user devices 102.

Advertiser devices 108 may communicate with the advertisement systems 104 (e.g., advertisement networks) via the network 110. The advertiser devices 108 may include, but are not limited to, smart phones, tablet computers, laptop computers, desktop computers, and additional computing device form factors. Advertisers may include any party that advertises goods, services, businesses, or any other entities. For example, advertisers may include, but are not limited to, companies seeking to advertise goods and/or services, advertising agencies, and application developers. Different advertisers may have different goals, depending on the advertisement subject matter. For example, some application developer advertisers may generate advertisements that are meant to promote installation of their applications. As another example, some developer advertisers may generate advertisements that are meant to promote traffic to their application. Some advertisers may generate advertisements that are meant to drive traffic to specific products and/or services.

Advertisers may use advertiser devices 108 to generate advertisement data in the advertisement systems 104. The advertisement systems 104 may generate advertisements for the user devices 102 based on the advertisement data generated by advertisers. Example advertisement data may include, but is not limited to, advertisement identification data (e.g., one or more IDs), advertisement display data (e.g., text, images, and/or videos), advertisement targeting parameters, and advertisement bids. Targeting parameters may specify one or more conditions that, if satisfied, may trigger display of an advertisement (e.g., in an application or website). A bid may indicate an amount the advertiser will pay for actions associated with the advertisement. For example, the bid may be an amount to be paid for showing the advertisement, a user selecting the advertisement, and/or performing an action after selecting the advertisement (e.g., installing an application or making a purchase).

Advertisements may be delivered to user devices 102 in websites and/or applications in a variety of formats. Example advertisements may include advertised links, graphical advertisements (e.g., banners), and/or video advertisements. Different advertisement formats may be placed in a variety of locations in websites and applications. For example, advertisements may be placed in a variety of locations on webpages, application pages, search engine results pages, social media pages, and gaming applications. The rendered advertisement data may also include a uniform resource locator (URL) that defines the location of a website and/or application that is accessed by selecting (e.g., touching/clicking) the rendered advertisement. The different advertisements may promote different user actions, such as installing an application, re-engaging with an application by opening the application, and/or other commerce actions (e.g., purchasing products/services). Advertisers may pay for one or more of the user actions associated with the advertisements, such as advertisement viewing/selection, application installation, and/or commerce actions.

The event system 106 may acquire event data that indicates how users engage with applications and websites (e.g., see FIG. 6A). For example, the event system 106 may receive event data generated by user devices 102 (e.g., mobile computing devices) while users are browsing websites and/or using applications (e.g., a native application) installed on the user devices. In some implementations, the event system 106 may receive event data from application/web modules 126, 128 (e.g., software libraries and functions/methods) that report the event data from the user device (e.g., from the applications). For example, event data may be generated by the user devices when users open/close an application, view application/web pages, and/or select links (e.g., hyperlinks) in an application or on a webpage. Application event data may include application events associated with application usage, such as opening an application, accessing a state of an application (e.g., a page), and making a purchase in the application. Web event data may include web events associated with website usage, such as accessing web pages and purchasing items on websites.

The event system 106 may store event data for a plurality of users (e.g., user devices). The event system 106 may also store event data for each user (e.g., each user device). Event data for a user may be referred to as “user-specific event data” or “user data.” The user data may be stored in a user data object 600 (e.g., see FIGS. 6A-6B). The detection system 100 may acquire the event data from the event system 106 for processing. For example, the detection system 100 may determine the anomaly metric values based on the acquired event data.

The event system 106 can track events that occur on user devices 102 over time and attribute the occurrence of some events to prior events. For example, the event system 106 may attribute the installation of an application to a prior user selection of a link, such as a hyperlink on a webpage or a banner advertisement. As another example, the event system 106 may attribute the purchase of an item on a website and/or application to a previously selected link. The attribution functionality provided by the event system 106 can be useful to a variety of parties, such as businesses, advertisers, and application developers that may wish to monitor performance of their applications/websites. Additionally, the attribution functionality provided by the event system 106 may also be used to provide various functionality to user devices 102, such as routing a user device into an application state in response to user selection of a web link. The attribution functionality may also be used to generate single user data objects for a single user (e.g., user device) across a plurality of applications and websites.

The environment includes one or more data providers 130. The data providers 130 may represent computing systems that provide event data (“external event data”) to the event system 106. In some implementations, the data providers 130 may be businesses that provide data management and analytics services. The data providers 130 may collect additional data (e.g., in addition to the event system 106) regarding how users are using the applications and websites. The event system 106 may process external event data received from the data providers 130 in a manner similar to event data received from the user devices 102. Example acquisition and processing of event data by the event system 106 is described with respect to FIGS. 6A-6B.

The advertisement systems 104 may provide advertisements to user devices 102 via websites and applications. In some implementations, the advertisement systems 104 may provide advertisements to websites/applications based on the satisfaction of targeting parameters. In some implementations, an advertisement system 104 may work with a plurality of different parties (e.g., business entities) to deliver advertisements via websites and applications. Each of the parties may provide locations in websites and/or applications for showing the advertisements. Each of the different parties that provides locations (e.g., “ad inventory”) for displaying advertisements may be referred to herein as a “sub-publisher.” In some cases, a sub-publisher may be referred to as a “secondary publisher.” Although an advertiser may advertise via advertisement systems 104 and sub-publishers, in some implementations, an advertiser may directly place advertisements using their own systems.

Each of the advertisement systems 104 may have a plurality of different sub-publishers (e.g., hundreds or thousands of sub-publishers). In some implementations, each sub-publisher may also further contract with additional sub-publishers having available ad inventory. In one example, ad networks may be provided by Google LLC of Mountain View, Calif., Liftoff Mobile of Redwood City, Calif., and InMobi of Bengaluru, India. Example sub-publishers may include, but are not limited to, various applications and websites used for ad placement, such as blogs, social influencers, or affiliates. Example mobile app “package names” that may appear as sub-publisher names may include, but are not limited to, com.pinterest.twa, com.yelp.android, com.weatherapp, com.topps.slam, com.supersolid.honestfood, com.glu.dashtown, com.playrix.gardenscapes, and com.whaleapp.solitaire.

Sub-publishers may display advertisements to users in a variety of locations on websites, applications, and emails. The various locations provided by sub-publishers for displaying advertisements may be referred to as “advertising inventory.” The opportunity to show an advertisement may be referred to as an “advertisement opportunity.” In some implementations, a sub-publisher may request an advertisement from the advertisement system 104 in real-time.

Events may include advertisement system data and/or sub-publisher data that indicates the advertisement system and/or sub-publisher associated with the events. Example data may include an advertisement system ID and/or sub-publisher ID associated with an event (e.g., an ad selection event). In some implementations, an advertisement system administrator (e.g., employee) may assign sub-publisher IDs (e.g., aliases) to different sub-publishers. Sub-publisher IDs may include numbers, characters, and/or symbols that identify the sub-publisher with respect to the advertisement system. A single advertisement system may assign different sub-publishers different IDs (e.g., unique IDs). Different advertisement systems may use different sub-publisher IDs for the same sub-publishers. As such, a single sub-publisher may not have the same assigned sub-publisher ID across different advertisement systems.

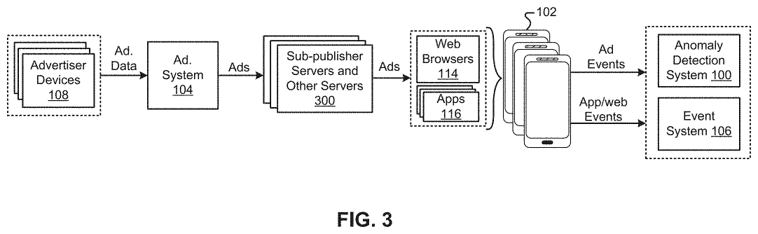

FIG. 3 is an example functional block diagram that illustrates the generation of advertisements, delivery of advertisements to user devices 102, and the acquisition of event data by the event system 106. In FIG. 3, advertisers (e.g., advertiser devices 108) generate advertisement data with the advertisement system 104. The sub-publisher servers 300, or other servers, deliver advertisements to user devices 102 via the web browser 114 (e.g., via websites) and/or applications 116. In FIG. 3, the event system 106 receives advertisement events (e.g., ad selections, ad impressions, etc.) along with other application and web events associated with the user devices 102. For example, the event system 106 may receive the event data from the user devices 102 or other sources (e.g., other servers). The detection system 100 of FIG. 3 may identify anomalous traffic based on the acquired event data.

As described herein, users may perform a variety of actions on user devices 102 with respect to websites and applications. Example user actions with respect to advertisements may include, but are not limited to, advertisement view events (e.g., “ad views”) and advertisement selection events (“ad selection events”). In some implementations, a user may perform downstream actions after selection of advertisements. For example, a user may install an application based on the selection of an advertisement (e.g., an application install event). As another example, a user may make a purchase based on selection of an advertisement (e.g., a commerce/purchase event). Other downstream application/web events may also be defined.

The event system 106 may log the web/application events for users over time in user data objects 600. A user data object for a single user may include one or more identifiers. For example, a user data object may have one or more internet protocol (IP) addresses associated with different events. A user data object may also include device IDs, such as IDs associated with web browsers (e.g., browser cookie IDs), application IDs, and advertising IDs. The web/application event data received at the event system 106 may also include advertisement system IDs and/or sub-publisher IDs. For example, an advertisement view/click event may include one or more IDs that identify (e.g., uniquely identify) the advertisement system 104 and one or more sub-publishers. In some implementations, the one or more IDs may be included in the click URL for the advertisement. In some implementations, the event data (e.g., in a click URL) may also indicate an advertisement name and an advertisement placement location (e.g., on the website/app). The event data may also include an event data type, which may specify whether the event data is from a click event or a view event.

The advertisers 108, advertisement systems 104, and sub-publisher sites 300 may track performance of advertisements. Example performance data may include, but is not limited to: 1) whether the advertisement was shown to the user (e.g., an ad impression), 2) where the advertisement was placed, and 3) whether the advertisement was selected by the user (e.g., an ad click). In some implementations, performance data may indicate whether selection of the advertisement was followed by a downstream event (e.g., in an application). Example downstream events may include, but are not limited to: 1) whether a purchase was made, 2) whether the user engaged with an entity (e.g., business or product) in an application/website that is relevant to the advertisement, and 3) whether an application was installed based on the advertisement selection. Advertisers may pay based on the performance of advertisements. For example, advertisers may pay for ad impressions, ad selections, and/or other user actions (e.g., installations, purchases, etc.).

FIGS. 4A-4B illustrate an example detection system 100. The detection system 100 receives event data from the event system 106. The event data store 602 may store a plurality of events for each user as user data objects (e.g., see FIGS. 6A-6B). In FIG. 4A, the event data 400 is illustrated as organized for processing according to advertisement system and sub-publisher (e.g., according to ad network IDs and sub-publisher IDs). The detection system 100 may process the event data 400 to identify anomalies, such as potentially fraudulent behavior. In some implementations, the detection system 100 may process data on a per-sub-publisher level for an advertisement system 104. In these implementations, the event system 106 and/or the detection system 100 may aggregate data for each sub-publisher by sub-publisher ID, as illustrated in FIG. 4A.

FIG. 4A illustrates example event data 400 used by the detection system 100 for processing. The event data 400 is organized according to advertisement system (e.g., ad system 1 data, ad system 2 data, . . . , and ad system N data). The event data for each advertisement system 104 is aggregated by sub-publisher (e.g., subpub 1 events, subpub 2 events, . . . , and subpub M events). FIG. 4A is only one example representation of event data 400. As such, although the event data 400 is illustrated as aggregated by sub-publisher in FIG. 4A, other data structures may be implemented.

The detection system 100 of FIG. 4A includes anomaly detection system modules 402 that may implement the functionality attributed to the detection system 100. FIG. 4B is a functional block diagram of an example set of anomaly detection system modules 402. Example operation of the detection system 100 in FIGS. 4A-4B are described herein.

The detection system 100 may detect a variety of anomalous activity associated with sub-publishers. In some examples, anomalous activity may include fraudulent activity, such as activity targeted at fraudulently acquiring advertising funds. For example, fraudulent activity may include attempts to drive ad views/selections, app installs, and/or commerce events in order to fraudulently acquire payments for sponsored activities (e.g., app installs, purchases, etc.). In a specific example, fraudulent activity may include app install fraud tactics designed to create fraudulent attribution of app installs to previous ad selections. In another specific example, app install fraud may include faking application installations.

In some cases, anomalous activity may be caused by click flooding/spamming (hereinafter “click flooding”). Click flooding may refer to a scenario where a large number of events (e.g., ad selection events) are associated with a sub-publisher. For example, in a click flooding scenario, large numbers of events for large numbers of devices may be generated in a manner that could not likely be generated by users during typical or heavy usage. Click flooding may be perpetrated in an attempt to capture downstream benefits, such as incorrect app install attributions. For example, the large number of ad selections generated during click flooding may result in some incorrect app install attributions for applications that were not actually a result of ad selection. Click flooding may be perpetrated in a variety of ways, such as through “ad stacking” (e.g., an actual ad click results in a plurality of generated ad selection events) or a website/application sending ad selection events that did not actually occur.

In some cases, anomalous activity may be caused by fake devices. In some cases, fake devices may include virtual devices, such as emulators and botnets. In some cases, fake devices may include actual devices, such as device farms (e.g., racks of devices) used for fraudulent activity. Actual devices may also include corrupted devices (e.g., malware) that produce fake web/application activity, which may or may not simulate a human's behavior.

In some cases, anomalous activity may include low quality traffic. Low quality traffic may include low quality interactions, such as a low app install rate for advertising clicks. Such low quality interactions may occur due to poor advertisement placement and/or placement that results in accidental user selection. The poor placement may be intentional or unintentional. In some cases, poor ad design may also result in poor performance.

In some implementations, the detection system 100 may identify anomalous activity (e.g., fraudulent activity) based on single device and/or IP address behavior. For example, the detection system 100 may identify anomalous behavior from a single event. In a specific example, a single device/OS version may be identified as anomalous activity when the single device/OS version is too outdated (e.g., greater than a threshold age). In some implementations, the detection system 100 may identify anomalous activity based on a very short ad selection to app install time (e.g., less than a human may perform). In some implementations, the detection system 100 may identify anomalous activity based on inconsistencies between an ad selection and app installation (e.g., different device OS/versions).

In some implementations, the detection system 100 may identify anomalous activity based on excessive traffic associated with an IP address, such as a large volume of events associated with the same IP address (e.g., a number of events greater than a human may perform). In some implementations, the detection system 100 may determine and/or acquire lists (e.g., blacklists) of anomalous/fraudulent IP addresses and devices.

The detection system 100 may be configured to detect anomalous traffic based on aggregate event data at the sub-publisher level. The detection system 100 may determine anomaly metric values for each sub-publisher based on the aggregate event data. The anomaly metric values may indicate different aspects of traffic/behavior associated with the sub-publisher. The anomaly metrics may be calculated based on analysis of the event data for a sub-publisher, such as counts/percentages of event data and timing associated with event data. In some implementations, the anomaly metrics may be application-specific calculations.

The detection system modules 402 may include anomaly metric determination modules 406 (e.g., Anomaly 1 metric determination mod, Anomaly 2 MD mod, . . . , and Anomaly N MD mod of FIG. 4B) that determine the metric values described herein. For example, each module may be configured to determine one of the anomaly metrics. The anomaly metric values may be stored in the anomaly detection data store 404. The anomaly detection data store 404 may also include other anomaly detection data described herein, such as threshold values/ranges, anomaly functions, anomaly function values, etc.

An anomaly metric value may indicate a level of confidence that the traffic associated with the metric is anomalous traffic (e.g., caused by fraud). The anomaly metric may have a minimum value (e.g., minimum confidence), maximum value (e.g., maximum confidence), and a plurality of intermediate confidence values. For example, in some implementations, the anomaly metric values may be integer values (e.g., 0-100) or decimal values (e.g., 0.00-1.00) that indicate a level of confidence that the traffic associated with the metric is anomalous traffic (e.g., caused by fraud). As described herein, in some cases, anomaly metric values may be percentage values that indicate a relative level of traffic/behavior in a sub-publisher network. For example, an anomaly metric value may indicate a percentage of users that opened an application within a period of time after installation. As another example, an anomaly metric value may indicate a percentage of users that made a purchase in an application.

In some implementations, the anomaly metric may be a binary value (e.g., 0/1) that indicates a determination by the detection system 100 that the anomaly metric value indicates anomalous activity (e.g., 1) or normal activity (e.g., 0). For example, the anomaly metric value may be flagged (e.g., set to 1) if the activity is determined to be likely caused by anomalous/fraudulent activity. In some implementations, the anomaly metric value may be initially calculated as a decimal value. A binary value may then be calculated based on the decimal anomaly metric value (e.g., based on a threshold value comparison).

In some implementations, the detection system 100 may use a threshold metric value (e.g., a percentage threshold) to determine whether to set the anomaly metric value to a 0/1. For example, the detection system 100 may set an anomaly metric value to 0/1 in response to the metric value being less/greater than the threshold metric value. In some implementations, the detection system 100 may use a plurality of threshold metric values for the determination. For example, an anomaly metric value may be considered anomalous activity if the anomaly metric value is outside of a range between minimum and maximum threshold metric values. In some implementations, the detection system 100 may implement multiple different ranges that correspond to anomalous/normal traffic determinations.

In some implementations, the detection system administrator (e.g., employees) may set the threshold metric values. In some implementations, the customers (e.g., developers/advertisers) may set the threshold metric values (e.g., via a customer interface). As such, the detection system 100 may user similar metric values across different sub-publishers and/or different threshold metric values defined by different customers.

In some implementations, the detection system 100 may have threshold metric values that are set based on comparisons to other sub-publishers. For example, sub-publishers that are determined to have normal traffic (e.g., non-fraudulent traffic) may be used to set the thresholds/ranges that define the anomalous traffic. In some implementations, administrators and/or customers may set the ranges according to the determined normal traffic based on manual inspection of the determined normal traffic.

In some implementations, the detection system 100 may set/recommend the threshold metric values based on analysis of sub-publisher traffic for one or more normal sub-publishers (e.g., non-fraudulent and trusted sub-publishers). In these implementations, the detection system 100 may set/recommend the threshold metric values using a statistical analysis (e.g., using statistical distributions) of the traffic associated with one or more normal sub-publishers. For example, the detection system 100 may determine one or more thresholds/ranges of normal metric values for normal sub-publishers. The detection system 100 may then determine that a sub-publisher is associated with anomalous (e.g., fraudulent) traffic if the traffic is outside of the thresholds/ranges for the normal metric values. In a specific example, if 25% of the users for a normal sub-publisher typically open an application within 5 hours of installation, sub-publishers having more than 50%, or less than 5%, of users that open the application within 5 hours may be flagged as having anomalous traffic with respect to the specific anomaly metric. In this case, the detection system 100 may set thresholds/ranges that are within tolerances of the determined normal sub-publishers.

In some implementations, the detection system 100 (e.g., recommendation modules) may generate thresholds/range recommendations for a customer (e.g., an advertiser). In some cases, the detection system 100 may identify thresholds with a high confidence level (e.g., based on normal/trusted sub-publishers) and automatically set the thresholds/ranges for the customer. In these cases, the detection system 100 may indicate the high level of confidence to the customer and prompt the customer for approval (e.g., in a recommendation interface). In some cases, the detection system 100 may indicate that thresholds/ranges may not be determined with confidence. In these cases, the detection system 100 may prompt the customer to set the thresholds/ranges. In these cases, the customer may user a customer interface to set the thresholds/ranges. The detection system 100 (e.g., recommendation modules) may adjust/update the thresholds/ranges over time.

The detection system 100 may calculate anomaly metric values, function values, and other values over a period of time. For example, the detection system 100 may calculate values over days, weeks, or months of data. Using data over multiple days may provide confidence in the labeling of activity as normal/anomalous. Using multiple days of data may also allow for more advanced fraud detection that may occur over a long period of time (e.g., days).

Example anomaly metrics described herein may be based on a variety of factors, such as device parameters, downstream events/timing, installation events/timing, user data object statistics, and/or custom defined factors. In some implementations, some applications and/or sub-publishers may use subsets of the anomaly metrics described herein due to limited applicability of some metrics to specific applications. For example, applications that do not include commerce events may not be associated with commerce-based metrics. The anomaly metrics described herein are only example anomaly metrics. As such, the detection system 100 may implement additional and/or alternative anomaly metrics other than those explicitly described herein. In some implementations, the customers may generate custom metrics that may be based on any of the factors described herein.

In some implementations, the detection system 100 may use device parameter anomaly metrics associated with device type, device brand, OS type, OS version, application version, or other device/OS parameters. For example, a device type metric, or other device/OS parameter metric, may include thresholds/ranges of expected device type usage. In a specific example, it may be expected that a small number of user devices are out of date and/or using out of date software (e.g., an older OS or application version). In this specific example, greater than a minimum threshold percentage of older devices/OSs may be considered anomalous activity. Such device parameter anomaly metrics may be detected when a fraudulent party is using an older version of an application. In some implementations, different device parameter anomaly metrics may be used for individual parameters, such as device type, OS version, etc. In some implementations, a single device parameter anomaly metric may be used to encompass a plurality of parameters, such as a combined percentage of outdated devices and outdated operating systems.

The detection system 100 may use one or more downstream anomaly metrics. A downstream anomaly metric may be based on a number/percentage of events that occur after application installation. For example, downstream anomaly metrics may be based on a percentage of application opens, application commerce events (e.g., purchases), registrations in the application, application logins, or any other event. In some implementations, application developers may define their own types of downstream events, which may be referred to as “custom events.” The one or more downstream anomaly metrics may also be based on custom events.

In some implementations, a downstream anomaly metric may be based on a single type of event. For example, a downstream anomaly metric may be based on a single percentage associated with the number of purchases after installation. As another example, a downstream anomaly metric may be based on a total number of events associated with applications. In some implementations, a downstream anomaly metric may be based on an aggregate of different types of events, such as a sum of different types of events. The aggregate event values may be useful in cases where different applications have different assigned event types. In these cases, an aggregate event value may provide flexibility for the detection system calculations and also provide a way to determine application engagement in a general sense.

In some implementations, downstream anomaly metrics may take into account an amount of time between different events, such as an amount of time to perform one or more actions since installation of the applications. For example, a downstream anomaly metric may be based on a percentage of users that open the application within a threshold period of time (e.g., within 12 hours) after installation. Each event type, or group of event types, may be associated with one or more anomaly metrics with different time amounts. For example, a first/second downstream metric may be based on a percentage of users that make a purchase (e.g., a purchase event) within 12/24 hours of installing the application. Other example time differences may include timing consistency between two events, such as application open time to a login time. With respect to anomaly metrics based on timing, it may generally be expected that users will perform some number of actions after installation. As such, levels of activity outside of normal activity may be considered anomalous activity.

In some implementations, downstream anomaly metrics may include values that indicate a portion of users that perform specific activities. For example, a downstream anomaly metric may indicate what portion of users (e.g., percentage of users) open the application after installation. As another example, a downstream anomaly metric may indicate what portion of users (e.g., percentage of users) make a purchase in the application after installation.

In some implementations, a downstream anomaly metric may include a ratio anomaly metric that may indicate a ratio of one type of event to another type of event. For example, an unusual ratio of event types may indicate anomalous traffic. In a specific example, an unusually large/small rate of application opens relative to registrations may indicate anomalous traffic. In another specific example, an unusually large/small ratio of first application opens relative to second application opens may indicate anomalous traffic.

In some implementations, the detection system 100 may use installation-based anomaly metrics (“install metrics”). For example, install metrics may be based on application installation after selection of an advertisement that promoted the installation. In one example, an install metric may include a percentage of installs within a time period of an associated advertisement selection. For example, the detection system 100 may expect a certain percentage of installs within a 3 hour time window, or other time window, after selection of an advertisement. Another example install metric may include a percentage of advertisement selections relative to installations. In this example, a low/high install rate may indicate a low quality site and/or fraudulent installation schemes to inflate installation numbers.

In some implementations, an install metric may be based on a percentage of downloads from one digital distribution platform relative to other digital distribution platforms. For example, for a specific operating system (e.g., ANDROID), there may be an expectation that a threshold percentage of downloads and installations should come from a specific popular digital distribution platform (e.g., the GOOGLE PLAY® store).

In some implementations, an install timing metric may be based on the relative times at which the download is requested at the digital distribution platform and the time at which the installation occurs. For example, an install timing metric may be based on the amount of time between selecting an installation on a digital distribution platform and installing the application on the user device. As another example, an install metric may require that a large percentage of installation time stamps occur after the download timestamp from the digital distribution platform, such as in limited cases in which timestamps for installation are prior to timestamps for download.

In some implementations, the detection system 100 may use anomaly metrics based on user data objects that include event data for single users or user devices (e.g., see FIG. 6B). In one example, the detection system 100 may use a user data object age anomaly metric (hereinafter “user age metric”) that is based on the age of the user data object. In a specific example, the detection system 100 may use a user age metric that indicates a percentage of user data objects that are less than a threshold age (e.g., less than 1 hour old, or other ages). In general, it may be expected that some percentage users are returning users and that their data is integrated into older existing user data objects. Therefore, greater than a threshold number of new user data objects (e.g., less than a threshold age) may indicate anomalous activity.

The detection system 100 may use a unique user data object ratio metric (hereinafter “user ratio metric”), such as a unique user data object ID ratio. For example, the detection system 100 may set thresholds/ranges for acceptable user data object ID ratios. Acceptable user data object ID ratios may be manually or automatically determined based on ratios present for other sub-publishers. In some cases, the metric may be tripped by the fraud tactic of “device ID resetting” to gain credit for a subsequent “Install” (e.g., that may be matched to a previous user data object). In one example, if 1000 people install an app, a small number (e.g., 5-10) may install it twice because they deleted the app for some reason. However, a larger number of reinstallations may be indicative of anomalous behavior. In some implementations, the metric may be based on the ratio of unique user data objects to the unique number of installs.

The detection system 100 may use one or more user activity metrics that may be based on data included in the user data objects. In one example, a user activity metric may indicate a threshold amount/rate of activity for a user. For example, if a user data object indicates that a user interacted with a large number of browsers within a short time period (e.g., more than is humanly possible), then the user data object may be flagged as associated with anomalous activity.

In some implementations, the detection system 100 may use IP address based metrics (“IP metrics”). Example IP metrics may include a ratio of unique IP addresses. If too many users (e.g., greater than a threshold) are from the same IP address, then the detection system 100 may determine that the IP metric indicates anomalous activity. For example, if there are 1000 installs, but only 200 IP addresses (instead of 950 IP addresses), the unique IP metric may indicate anomalous activity. In some cases, applications (e.g., server-implementations) may disable this metric due to a large amount of traffic associated with the same/similar IP address. In some implementations, an IP rate metric may be based on the occurrence of traffic that comes from blocked IP addresses (e.g., blacklisted IP addresses). For example, if greater than a threshold level of event data is associated with blocked IP addresses, the IP rate metric may indicate that the traffic is anomalous traffic.

In some implementations, the detection system 100 may use advertisement tracking anomaly metrics that are based on advertisement tracking features associated with the user devices. In this example, some users may disable advertisement tracking on their devices. Disabling advertisement tracking may prevent sharing of an advertisement ID by the application. In some cases, it is expected that some percentage of users may disable advertisement tracking. For example, a small percentage of users may disable advertisement tracking. In this case, anomaly metrics that reflect percentages greater than the expected small percentage may be defined as anomalous behavior.

In some implementations, the detection system 100 may use a device modification anomaly metric. The device modification anomaly metrics may include software modifications, such as removing software restrictions that may be in place by the device manufacturer. Example software modifications may include “jailbreaking” a device (e.g., on the IOS operating system) or “rooting” a device. In some implementations, the detection system 100 may expect a small percentage of devices to include this type of modification. As such, the detection system 100 may use a low maximum threshold value (e.g., 1-3%) that may indicate anomalous behavior when it is exceeded.

In some implementations, the detection system 100 may use upstream activity metrics. Example upstream activity metrics may use events that occur prior to other events (e.g., prior to installation events, commerce events, etc.). For example, if the device recently clicked on 10 ads within the 24 hours prior to the advertising conversion event, it could be used as an uncommon anomaly.

In some implementations, the detection system 100 may use application navigation pathway metrics that may be based on measured pathways (sequence of event activity) for anomalies. In a specific example, a common event pathway may be: “homepage”, “sign-in”, “product page”, “shopping cart”, and “check out.” For example, 30% of users may commonly follow this expected pathway. If a sub-publisher shows a consistently high percentage of an uncommon pathway, the traffic may be flagged.

In some implementations, the detection system 100 may use atypical mismatch or combination of attributes metrics. The following are examples of uncommon or invalid attribute pairings that may be detected and flagged: 1) an iPhone with an ANDROID OS version, 2) a screen dimension size not typical for the device model (e.g., a tablet with a screen dimension of 200×200), and 3) an Australian telecom carrier paired to Canadian geo-location.

Additional example anomaly metrics may include device screen dimension metrics, which may cause sub-publishers to be flagged for the presence of uncommon screen dimensions, for example. Other example anomaly metrics may include acceleration/gyro metrics, which may cause sub-publishers to be flagged for device movement, tilt angle, or other motion/position. Other example anomaly metrics may include GPS location metrics, which may cause sub-publishers to be flagged for anomalous geolocations (e.g., a threshold number of devices in small area). Other anomaly metrics may include battery power metrics, which may check for battery power level anomalies. Other anomaly metrics may include app screen usage time metrics, which may utilize the time an application is on screen or used to detect anomalies. Other example anomaly metrics may include microphone sound/noise levels, which may monitor the volume of input sound(s) to detect anomalies.

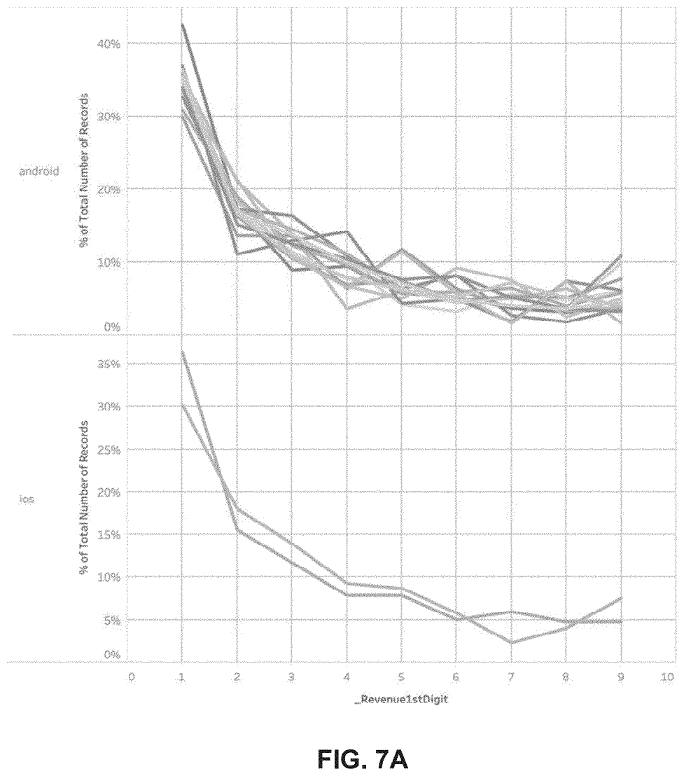

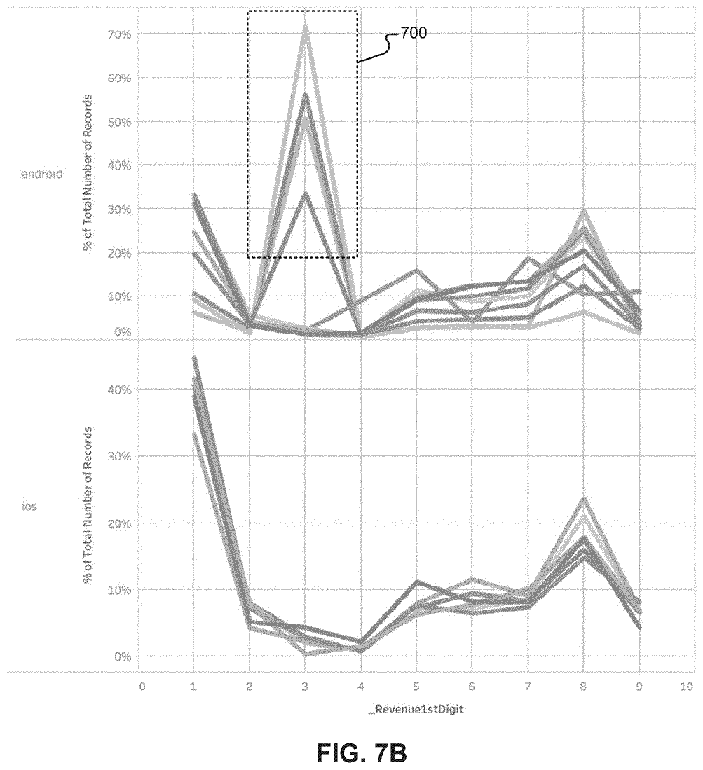

In some implementations, the detection system 100 may use one or more statistical distribution metrics to detect anomalous traffic. For example, the detection system 100 may use one or more statistical distributions for events associated with applications, such as commerce events (e.g., purchase events, reservation events, etc.). In a specific example, the detection system 100 may use one or more Benford's law metrics. Example Benford's law metrics may be based on distributions of digits associated with revenue. In one case, the detection system 100 may detect anomalous traffic based on a deviation from Benford's law, such as a deviation from a frequency distribution of leading digits in which leading digits from 1-9 gradually appear fewer times in the frequency distribution. FIG. 7A illustrates an example revenue leading digit distribution for a commerce application (ANDROID and IOS versions) for a plurality of ad partners or sub-publishers (e.g., each line is for a separate sub-publisher). FIG. 7A illustrates an example Benford's law distribution in which there are not deviations.

In some implementations, the frequency distribution of leading digits may not follow Benford's law. In these cases, the detection system 100 may detect anomalous activity based on a deviation from a typical frequency distribution of first digit revenue and/or trusted sub-publisher distributions. For example, FIG. 7B illustrates an example distribution of first digit revenue that does not follow Benford's law, but does illustrate a deviation from typical distributions at 700 that may be due to anomalous activity. In some implementations, the transactions may be identified as anomalous (e.g., fake) based on separate validations (e.g., separate receipt IDs assigned to purchases).

In some implementations, the detection system 100 may use an anomalous traffic metric that may be based on an amount of traffic for a sub-publisher that was determined to be anomalous (e.g., flagged as anomalous) based on any of the factors described herein. In general, greater than a threshold amount of blocked traffic for a sub-publisher may indicate that the sub-publisher should be blocked.

The detection system 100 may identify sub-publisher traffic as anomalous traffic based on one or more of the anomaly metrics associated with the sub-publisher. For example, the detection system 100 (e.g., anomaly detection function modules 408) may implement an anomaly detection function that determines an anomaly function value that indicates whether a sub-publisher is associated with anomalous activity. The anomaly function value may indicate a likelihood that the sub-publisher is associated with anomalous traffic.

The anomaly function may use binary anomaly metric values and/or other metric values (e.g., decimal values and/or integer values). The meaning of the anomaly function value may depend on the types of anomaly metric values used. Example anomaly functions using binary and decimal values are now described.

In some implementations, the anomaly function may use binary anomaly metric values (e.g., 0/1). In these implementations, the anomaly function may add the values to determine an initial anomaly function value. Adding the binary values may indicate a count of anomaly metrics, which in turn indicates anomalous activity. For example, a greater count may indicate that a greater number of anomaly metric values indicate anomalous activity. In these cases, if the anomaly function value is greater than a threshold function value count, the anomaly function value may be set to 1 in order to indicate that the sub-publisher is associated with anomalous traffic. Otherwise, the function value may be set to 0 to indicate that the sub-publisher is not associated with anomalous activity.

In some implementations, the anomaly function may use decimal anomaly metric values, such as 0.00-1.00, where numbers closer to 1.00 are more indicative of anomalous activity. In these implementations, the anomaly function may add the values to determine an initial anomaly function value. Adding the decimal values may mean that a larger initial anomaly function value may be more indicative of anomalous sub-publisher activity. In these cases, if the anomaly function value is greater than a threshold function value, the anomaly function value may be set to 1 in order to indicate that the sub-publisher is associated with anomalous traffic. Otherwise, the function value may be set to 0 to indicate that the sub-publisher is not associated with anomalous activity.

In some implementations, the anomaly function value (e.g., binary or decimal) may include anomaly metric weightings. An anomaly metric weighting may be a value that is multiplied by the corresponding anomaly metric value in the anomaly metric function. Different anomaly metric weightings may be used for different anomaly metrics. The magnitude of the anomaly metric weighting may be used to emphasize the importance and/or accuracy of some anomaly metrics relative to others. For example, anomaly metric values that are more indicative of anomalous activity may have larger weightings applied.

Anomaly detection functions may also include other types of scoring/rules (e.g., other than counting/weighting). For example, in some implementations, an anomaly detection function may be configured to indicate anomalous activity for a sub-publisher if one or more specific subsets of anomaly metrics indicate anomalous activity. In this example, one or more subsets of anomaly metric values may trigger the detection system 100 to identify the sub-publisher as being associated with anomalous activity.

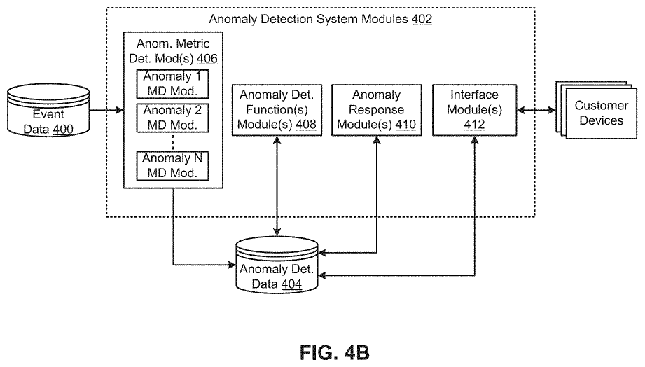

FIG. 5 shows an example chart for a single application (App ID 123) on an ad network (a_test) for a single sub-publisher (abcd). The chart includes a plurality of anomaly metric values and expected ranges. The chart indicates anomalous activity (abnormal activity) with a 1. The chart includes anomaly function values for a counting function and a scoring function. The counting function counts the anomaly metric values. The scoring function (scenario 2) shows the effects of weighting on the open rate metric. Specifically, weighting an anomaly metric may cause an inflation in the score, which may indicate a greater likelihood of anomalous activity.

In some implementations, the detection system 100 may group data from multiple sub-publishers into a single grouping for analysis. For example, the detection system 100 may group data for multiple sub-publishers together into a single grouping if there is too little data (e.g., less than a threshold number of installs, purchases, sources of data, etc.) for each of the multiple sub-publishers. In a specific example, advertising network A may have 100 total sub-publishers with a first set of 5 sub-publishers each having sufficient volume (e.g., install numbers) and the remaining 95 sub-publishers having insufficient volume (e.g., very few installs). In this specific example, the detection system 100 may make 6 judgments across advertising network A, which may include 5 separate judgments for the first 5 sub-publishers (e.g., 1 fraud judgment for each sub-publisher) and another single judgment (e.g., 1 fraud judgment) for the grouping of 95 remaining sub-publishers. The grouping of sub-publishers may be effective at detecting fraud in the case where advertising networks modify sub-publisher IDs over time (e.g., to mask fraudulent activity). In some implementations, the detection system 100 may automatically group the sub-publishers by commonalities among the different sub-publishers other than the sub-publisher IDs. For example, the detection system 100 may use machine learning techniques to group sub-publishers based on commonalities.

The detection system 100 (e.g., anomaly response modules 410) may generate a variety of anomaly responses. In some implementations, the detection system 100 may flag a sub-publisher as being associated with anomalous activity. In one example, the anomaly detection system 100 may flag a sub-publisher as potentially fraudulent. In this case, the detection system owners/operators (e.g., employees) may provide the data (e.g., flagged data and associated events) to the relevant parties.

The detection system 100 may automatically take a variety of actions in response to determining that a sub-publisher is associated with anomalous activity (e.g., fraudulent activity). In some implementations, the detection system 100 may automatically notify the relevant parties of the potentially fraudulent sub-publishers. For example, the detection system 100 may notify the advertisement system 104 and advertisers associated with the sub-publisher. In cases where an advertisement system 104 is associated with a plurality of sub-publishers that are potentially fraudulent, the detection system 100 may notify the advertisers so the advertisers may decide to cease advertising with the advertisement system 104. In some implementations, the detection system 100 may notify the sub-publishers of anomalous activity in case the sub-publisher is being unwittingly used for anomalous activity (e.g., fraud).

In some implementations, the detection system 100 may modify event data (e.g., user data objects) associated with a sub-publisher that has been flagged. For example, the detection system 100 may annotate (e.g., flag) the events associated with the sub-publisher as being potentially fraudulent. In a specific example, the detection system 100, or other party, may annotate potential attributions in data and block/rescind other financial obligations between parties that are based on the events for the flagged sub-publisher. For example, the detection system 100 may annotate (e.g., flag) an app installation attribution to an advertisement selection if the ad selection was associated with a sub-publisher that was identified as potentially fraudulent. Downstream events associated with flagged events may also be annotated as potentially fraudulent to prevent future attributions/payments. In some implementations, after determining that a sub-publisher is associated with anomalous activity, the relevant parties may focus on a more detailed fraud analysis at the device ID or IP address level.

The detection system 100 (e.g., interface modules 412) may provide a customer interface, such as one or more interfaces for advertisers and app developers. The customer interface may be an application-based interface and/or a web-based interface. In some implementations, the customer interface may display data associated with anomaly detection (e.g., in a dashboard). For example, the customer interface may display anomaly metric values, anomaly function values, and the data used to generate the values. The customer interface may also display data (e.g., user data objects and event data) that has been flagged as anomalous activity.

In some implementations, the customer interface may include user interface elements for inputting a variety of different detection system parameters. For example, the customer may input the metric types to be used for anomaly detection, anomaly metric value thresholds/ranges, anomaly detection functions and rules, anomaly metric function weightings, custom anomaly metrics, and any other configurable system parameters described herein.

The detection system 100 may provide reports for different parties, such as detection system administrators, customers (e.g., advertisers), ad systems, and sub-publishers. Reports may include any of the data described herein, such as event counts, metric values, thresholds/ranges, and detection function values. The data may be organized in a variety of ways. For example, the data may be organized by ad network, sub-publisher, application, operating system, and/or other factors. In some implementations, the reports may include formatting (e.g., text formatting, color coding, graphical annotations, etc.) that indicate whether the data is associated with anomalous traffic or normal traffic. For example, the reports may include color coded data that indicates whether traffic is normal (e.g., green), suspicious/undefined (e.g., orange), or anomalous (e.g., red).

In one example, the detection system 100 may generate spreadsheet reports (e.g., tables) for a party that include any of the data described herein, along with formatting that indicates whether the data is associated with normal traffic or anomalous traffic. For example, a spreadsheet for an application may include a group of rows for an ad system, where each row is for data associated with a single sub-publisher of the ad system. In this example, each row may include a variety of data associated with the sub-publisher, such as columns for numbers of events (e.g., clicks, installs, CTI rates, etc.), anomaly metric values, and other data described herein. The spreadsheet may also include formatting that indicates whether the data is associated with anomalous traffic. For example, different spreadsheet cells or rows may be color coded to indicate whether activity is normal (e.g., green), anomalous (e.g., red), or in between (e.g., orange). Additionally, or alternatively, spreadsheets may include graphical indicators, such as color-coded shapes, or other graphical indicators, to indicate that specific values are normal or anomalous. The data provided to a party may be modified (e.g., redacted) by the detection system 100, depending on permissions. A party may quickly and easily identify sub-publishers that are associated with normal/anomalous activity using one or more reports (e.g., spreadsheets) described herein.

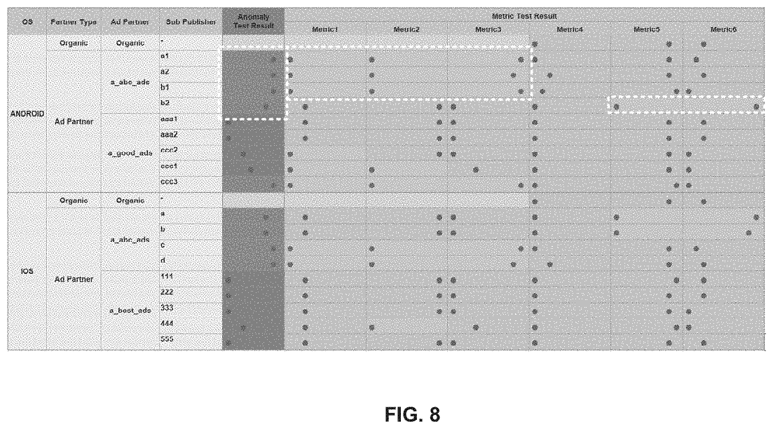

FIG. 8 illustrates an example spreadsheet report. The report includes rows for ad networks (ad partners) and associated sub-publishers. The report also includes shading (e.g., coloring) that indicates values that may be associated with anomalous activity. For example, the sub-publishers a1, a2, b1, and b2 for ad partner a_abc_ads includes flagged anomaly test results and metrics (e.g., included in the broken white lines). Other cell values may also indicate normal or anomalous behavior.

In some implementations, a partner of the event system 106 and/or detection system 100 can integrate with the event system 106 in a variety of ways. For example, the partner can retrieve application and web module components 126, 128 that the partner can modify and include into their application(s) and website. The application module components may include software libraries and functions/methods that may be included in the partner's application. The functions/methods may be invoked by the application to request system links 132, handle the selection of system links 132, transmit event data to the event system 106 (e.g., application open events), and handle data received from the event system 106. The web module components may include software libraries and functions/methods that may be included in the partner's website. The functions/methods (e.g., JavaScript) may be invoked to provide the website with various functionalities described herein with respect to the event system 106. For example, the functions/methods may be invoked to request system links 132, handle the selection of system links 132, transmit event data to the event system 106 (e.g., webpage view events), and handle data received from the event system 106. The application and web module components can include computer code that provides features for communicating with the event system 106. The partners may also generate system links 132 for inclusion in their applications/websites and or other applications/websites.

FIG. 6A illustrates an example event system 106. The event system 106 includes an event data acquisition and processing module 604 (hereinafter “event processing module 604”) that acquires event data from a plurality of sources. Example event data may include app event data, web event data, and system link data. The event processing module 604 can generate user data objects 600 (e.g., see the example user data object 600 of FIG. 6B) based on the acquired event data. The event processing module 604 can also generate aggregate event data 606 based on the received event data and user data objects. The aggregate event data 606 may indicate how a plurality of users are engaging with partner applications and websites. The event processing module 604 can update the user data objects 600 and aggregate event data 606 over time (e.g., in response to newly received event data). The event system 106 includes an event data store 602 that can store received event data, including user data objects 600 and aggregate event data 606.

The event data received by the event system 106 may include device identifiers (“device IDs”) that identify the user device that generated the event data. The event system 106 can use the various device IDs for tracking events (e.g., application installations, application opens, and link selections) and attributing events to prior events. Some device IDs may be associated with a web browser on a user device (e.g., set by a web browser). Device IDs associated with the web browser may be referred to herein as “web IDs.” Example web IDs may include browser cookie IDs, which may be referred to as web cookies, internet cookies, or Hypertext Transfer Protocol (HTTP) cookies. Some device IDs may be associated with applications installed on the user device other than the web browser. In some cases, the device IDs may be operating system generated IDs that installed applications may access. Additional example device IDs may include advertising IDs, which may vary depending on the operating system (OS) on the user device.

The event system 106 can store event data for individual users (e.g., in user data objects 600). Each user data object may include data (e.g., a list of events) indicating how a person uses one or more user devices over time. For example, a single user data object may include data indicating how a person uses a web browser and multiple applications on a single user device (e.g., a smartphone). In a more specific example, a single user data object may include data indicating how a person interacts with a partner's website and application. The event system 106 may store one or more user data objects for each user device from which event data is received. The event system 106 may update existing user data objects in response to receiving event data associated with device IDs that are the same as device IDs included in existing user data objects. The event system 106 may generate a new user data object for each event associated with a new device ID. Since a single user device may generate multiple device IDs (e.g., web IDs and/or advertising IDs), the event system may store multiple user data objects for a single device. The event system 106 can include matching functionality that identifies different user data objects that belong to the same user device. For example, the event system 106 may match two user data objects based on data including, but not limited to, the Internet Protocol (IP) addresses of the user devices, OS names, OS versions, device types, screen resolutions, and user identification data (e.g., a username). In some examples, the event system 106 may combine matching user data objects (e.g., combine event data).

In some cases, the event system 106 (e.g., the event response module 608) can leverage user data objects 600 to provide responses to a user device 102 based on past events generated by the user device 102, as illustrated by the following example. If a user selects a link for accessing content in an application that the user device does not have installed, the event system 106 (e.g., event response module 608) can log the selection of the link and can redirect the user to download/install the application. Upon opening the newly installed application, the application can transmit an event to the event system 106. The event system 106 (e.g., event response module 608) may match the two user data objects and, based on the match, the event system 106 can direct the opened application to the content linked to by the previously selected link. In this example, the opening of the application and installation of the application may be attributed to the selection of the link.

In some implementations, the event system 106 can generate and store data for use in user-selectable links, such as advertisement links and/or links to shared content. For example, the event system 106 may generate and store a system link data object that includes a system Uniform Resource Identifier (hereinafter “system URI”) and data. System link data objects can be stored in the system link data store 610. The system URI may indicate the network location of a system link data object (e.g., using a domain/path). The system URI may be included in a user-selectable link (referred to herein as a “system link 132”) in an application or on a website. Example user-selectable links may include hyperlinks, GUI buttons, graphical banners, or graphical overlays. In response to selection of a system link 132, a user device may access the event system 106 (e.g., the event response module 608), which may provide a response to the user device. For example, in response to receiving a system URI from a user device, the event response module 608 can retrieve data corresponding to the received system URI and perform a variety of functions based on the retrieved data. In one example, the event response module 608 can redirect the user device based on the data (e.g., to download the application or to a default location). In another example, the event response module 608 may pass the data (e.g., a discount code, user referral name, etc.) to the user device so that the user device can act based on the data. The event system 106 may log the selection of the system links and attempt to match the system link selections to other events included in the same user data objects or different user data objects.

The event system 106 can handle events and respond to the user devices 102. In one example, if the event system 106 has attributed an incoming event to a prior event, the event system 106 may handle the incoming event in a manner that depends on the prior event. In an example where the installation of an application is attributed to the prior user selection of a system link 132, the event system 106 may route the newly installed application according to the system URI of the prior selected system link. In some cases, if the event system 106 receives a system URI (e.g., event data indicating a click on a system link), the event system 106 can retrieve data associated with the system link. The event system 106 can then respond to the user device according to the data. For example, the event system 106 may route the user device (e.g., redirect the web browser) according to the data. The response provided by the event system to the user device can vary, depending on a variety of factors. In some cases, the event system may route the user device (e.g., web browser and/or application) in response to a received event. In some cases, the event system may transfer data to the user device in response to a received event.

In some implementations, the event data may include user identification data that identifies a user (e.g., a user ID). User identification data may include a username/login. In some cases, the username may include an email address. The user identification data may identify a user with respect to a website/application. In one specific example, the username and app ID pair may identify a user uniquely with respect to the application/website associated with an app name/ID. In some implementations, the user ID may be replaced by another identifier (e.g., a developer provided identifier). For example, the user ID may be replaced by an ID assigned by the developer that is a hash of a user ID or an internal app-provider database ID.

In some implementations, event data may include source data that indicates the source of an event. As described herein, event data may be generated in response to a user action, such as a user interacting with a link, webpage, or application state. For example, event data may be generated when a user views a webpage or application state, or when a user interacts with system links or other GUI elements included on a webpage or application state. The source data (e.g., on a per-event basis) may describe the network location and/or circumstances associated with the generation of the event data (e.g., the location where a link was viewed or selected).

The event data generated by the user device may be characterized as application event data (“app event data”) or web event data. The characterization of events may depend on whether the event data is generated via user interactions with the web browser or other applications. Web events may generally originate from the web browser and may be associated with a web ID (e.g., a cookie ID). For example, web events may refer to events generated by the web module 128 of the partner's website 118. App events may generally originate from an application other than the web browser and may be associated with a device ID (e.g., a device ID other than a web ID, such as an advertising ID). For example, app events may refer to events generated by the app module 126 of the partner's application 124. Another type of event described herein is a link selection event that generates link data. The link selection event may be generated by the selection of a system link 132 on a partner's website/application or in another website/application. A link selection event may be characterized as either an app event or web event, depending on how the user device handles the link selection. The event data may be received as HTTP requests or HTTP secure (HTTPS) requests in some cases. The event system 106 may handle link events (e.g., by sending a response) based on a variety of factors described herein, such as how the user device is configured to handle selection of a system link.

The user device may transmit app event data (e.g., according to the app module) in response to a variety of different user actions. For example, the user device may transmit app event data in response to: 1) an application being opened (referred to as an “app open event”), 2) the user closing the application (referred to as an “app close event”), 3) the user adding an item to a shopping cart or the user purchasing an item (referred to generally as “application commerce events”), 4) the user opening the application after installation (referred to as an “app installation event”), 5) the user opening the application after reinstallation (referred to as an “app reinstallation event”), 6) the user requesting that a system URI be created by the event system and transmitted back to the user device (e.g., in order to share content), 7) a user accessing a state of the application (e.g., an app page), 8) a user performing an action that the app module has been configured by the operator of the event system to report, and 9) the user performing any other action that the app module has been configured by the partner to report to the event system (i.e., a custom event defined by the partner). For example, a partner may define custom events to indicate that a specific application state (e.g., application page) or specific piece of content is viewed or shared.

The app event data received by the event system 106 may include, but is not limited to: 1) a device ID (e.g., an advertising ID, hardware ID, etc.) and other IDs described herein, 2) an application name/ID that indicates the application with which the app event data is associated, 3) user identification data that identifies a user of the app (e.g., a username), 4) source data indicating the source of the event data, and 5) device metadata (e.g., user agent data), such as an IP address, OS identification data (e.g., OS name, OS version), device type, and screen resolution. The app event data may also include an event identifier that indicates the type of event. For example, the event identifier may indicate whether the app event is an app open event, an app close event, an app installation event, an app reinstallation event, a commerce event, or a custom event that may be defined by the developer in the app module. In the case the app event is an app open event that resulted from user-selection of a link (e.g., a system link), additional app event data may be transmitted by the user device, such as the URI (e.g., a system URI) that caused the user device to open the application. In some cases, the app event data may also include a web ID (e.g., appended to the system URI) associated with the URI. In some cases, the app event data may also include app-specific metadata, such as entity information (e.g., a business ID number in the application).

The event system 106 may perform a variety of different operations in response to receiving event data. For example, the event system may: 1) timestamp the received app event data (or use a received timestamp), 2) determine the source of the app event, 3) log the event data (e.g., update a database of user engagement), 4) determine if the app event can be attributed to any previous event, and/or 5) determine whether an app open event is an install event or a reinstall event. In the case the event system receives a system URI, the event system may acquire data associated with the system URI. In the case the event system receives a link generation request, the event system can generate a link data object and transmit the system URI back to the user device.

The user device may transmit web event data (e.g., according to the web module) in response to a variety of different user actions. For example, the user device may transmit web event data in response to a user accessing a webpage (referred to as a “webpage view event”). Accessing a webpage may be the start of a web session (e.g., the first webpage access on the site) or a subsequent page view. The user device may also transmit web event data in response to the user adding an item to a shopping cart or the user purchasing an item (referred to generally as “web commerce events”), the user requesting that a system URI be created by the event system and transmitted back to the user device (e.g., in order to share content), a user performing an action that the web module has been configured by the operator of the event system to report, and the user performing any other action that the web module has been configured by the partner to report to the event system (i.e., a custom web event defined by the partner). For example, a partner may define custom events to indicate that a specific webpage or specific piece of content is viewed or shared.

The web event data received by the event system may include, but is not limited to: 1) a web ID, 2) the website name/ID, which may correspond to the app name/ID or app ID in the event system, and 3) device/browser metadata (e.g., user agent data), such as IP address, OS identification data (e.g., OS name, OS version), device type, and screen resolution. The device/browser metadata may be extracted from the user agent sent by the web browser. The web event data may also include user identification data that identifies a user of the website (e.g., a username), source data indicating the source of the web event data, and an event identifier that indicates the type of event. For example, the event identifier may indicate whether the web event is a webpage view event, a commerce event, a link creation event, a sharing event, or a custom event defined by the developer in the web module. The web event data may also include the URI/URL for the current page and a referring URI/URL.

The event system 106 may perform a variety of different operations in response to receiving web event data. For example, the event system may: 1) timestamp the received web event data (or use a received timestamp), 2) determine the source of the web event, 3) log the web event data, and/or 4) determine if the web event can be attributed to any previous event. In the case the event system receives a link generation request, the event system can generate a system link data object and transmit the system URI back to the user device. The event system may also set a web ID on the user device in the case the web browser does not include a web ID.

User selection of a system link may be handled by the user device in a variety of ways, depending on how the user device is configured. In some cases, selection of a system link may cause an application to open, in which case the selection of the system link (e.g., the system URI) is passed to the event system in the app open event. In other cases, the selection of a system link is handled by the web browser, which accesses the event system using the system URI associated with the system link. In implementations where the web browser accesses the event system in response to user selection of a system link, the link event data may include a web ID and device/browser metadata. The device/browser metadata (e.g., user agent data) may include an IP address, OS identification data (e.g., OS name, OS version), device type, and screen resolution.

The event system 106 may perform a variety of different operations in response to receiving link event data, including, but not limited to: 1) timestamping the received link event data (or using a received timestamp), 2) determining the source of the link event data, 3) logging the link event data, 4) retrieving data for the received system URI, 5) routing the user device to a location (e.g., a digital distribution platform for downloading the application, a default site, or other site) based on the retrieved data, and 6) setting a web ID in the case the web browser does not include a web ID.

The partner, or a user device (e.g., app/web module), can request system URIs from the event system. In the request, the partner (or the user device) can specify operations and data to be associated with a system URI. The system URI may include a domain name (e.g., example.com or www.example.com) and a path (e.g., example.com/path_segment1/path_segment2/). The domain name and path can be used to access the data object associated with the system URI via the network. In some cases, the scheme for the system URI may be a web uniform resource locator (URL) using http, or another scheme, such as ftp.

User data objects may also include data that may be derived from the list of events for the app/website. Additional data may include, but is not limited to, a) a timestamp indicating the most recent usage of the app/website, b) a timestamp indicating the last time the app/website was accessed on a mobile device, c) a timestamp indicating the last time the app/website was accessed on a desktop device, d) activity data that indicates how often and when the app/website was used over a period of time (e.g., which days the app/website was used over a predetermined number of previous days), e) activity data that indicates how often the app/website was used on a mobile device, f) activity data that indicates how often the app/website was used on a desktop device, and g) a timestamp indicating the first time the user used the app/website (e.g., an earliest event in the list of events).

The event system 106 (e.g., the event processing module 604) can generate aggregate event data 606 described herein based on the app event data, web event data, and system link data. Aggregate app event data may include aggregate app usage data that indicates a number of users of the application over time. Example aggregate app usage data may include, but is not limited to, the number of daily active users (DAU) for the application and the number of monthly active users (MAU) for the application. The aggregate app usage data may also include the number of app events over time for a plurality of users. For example, aggregate app usage data may include the number of application opens over time, the number of different application states accessed over time, and the number of purchase events over time. In some implementations, the aggregate app event data may indicate a number of times systems links were generated for applications, used to access applications, and/or selected within an application state.

The aggregate app event data can be calculated for different geolocations, such as cities, states, and/or countries. For example, the aggregate app usage data may indicate the DAU for different countries. The aggregate app event data can also be calculated for different languages, different device types (e.g., smartphone type, laptop, desktop), different operating systems, different times of the day, and days of the week. The aggregate app event data can be calculated according to any combination of the parameters described herein. For example, the aggregate app event data may include a DAU count for a set of specific devices in a specific country.

In some implementations, the event system 106 (e.g., the event processing module 604) may generate aggregate web event data that indicates a number of web events over a period of time, such as a number of times a domain/page was accessed. The aggregate web event data can be calculated for different geolocations, countries, languages, device types, operating systems, times of the day, and days of the week. The aggregate web event data can be calculated according to any combination of the parameters described herein. In some implementations, the aggregate web event data may indicate a number of times systems links were generated and/or accessed. In some implementations, the aggregate event data can be normalized.

Modules and data stores included in the systems (e.g., 100, 106) represent features that may be included in the systems of the present disclosure. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with memory components and I/O components. For example, the one or more processing units may be configured to communicate with memory components and I/O components via the interconnect components.

A memory component (e.g., main memory and/or a storage device) may include any volatile or non-volatile media. For example, memory may include, but is not limited to, electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray Disc), or any other memory components.

Memory components may include (e.g., store) data described herein. For example, the memory components may include the data included in the data stores. Memory components may also include instructions that may be executed by one or more processing units. For example, memory may include computer-readable instructions that, when executed by one or more processing units, cause the one or more processing units to perform the various functions attributed to the modules and data stores described herein.

The I/O components may refer to electronic hardware and software that provides communication with a variety of different devices. For example, the I/O components may provide communication between other devices and the one or more processing units and memory components. In some examples, the I/O components may be configured to communicate with a computer network. For example, the I/O components may be configured to exchange data over a computer network using a variety of different physical connections, wireless connections, and protocols. The I/O components may include, but are not limited to, network interface components (e.g., a network interface controller), repeaters, network bridges, network switches, routers, and firewalls. In some examples, the I/O components may include hardware and software that is configured to communicate with various human interface devices, including, but not limited to, display screens, keyboards, pointer devices (e.g., a mouse), touchscreens, speakers, and microphones. In some examples, the I/O components may include hardware and software that is configured to communicate with additional devices, such as external memory (e.g., external HDDs).

In some implementations, the systems may include one or more computing devices that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the systems may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the systems may be configured to communicate with the network 110 (e.g., the Internet). The one or more computing devices of the systems may also be configured to communicate with one another (e.g., via a computer network). In some examples, the one or more computing devices of the systems may include one or more server computing devices configured to communicate with user devices. The one or more computing devices may reside within a single machine at a single geographic location in some examples. In other examples, the one or more computing devices may reside within multiple machines at a single geographic location. In still other examples, the one or more computing devices of the systems may be distributed across a number of geographic locations.

What is claimed is:

1. A method comprising:
acquiring, at a computing device, first aggregate event data for a first sub-publisher, wherein the first aggregate event data indicates aggregate user activity across a plurality of applications associated with the first sub-publisher;
acquiring, at the computing device, second aggregate event data for a plurality of additional sub-publishers, wherein the second aggregate event data indicates aggregate user activity across a plurality of applications associated with the plurality of additional sub-publishers;
determining, at the computing device, a plurality of anomaly metric values for the first sub-publisher based on the first aggregate event data and the second aggregate event data;
determining, at the computing device, an anomaly function value for the first sub-publisher based on the anomaly metric values for the first sub-publisher, wherein the anomaly function value indicates a likelihood that the first sub-publisher is associated with fraudulent user activity;
determining, at the computing device, whether the user activity across the plurality of applications associated with the first sub-publisher is fraudulent based on the anomaly function value; and
notifying a customer device of fraudulent activity in response to determining that the user activity associated with the first sub-publisher is fraudulent.

2. The method of claim 1, further comprising determining the anomaly metric values based on a comparison of the first aggregate event data and the second aggregate event data.

3. The method of claim 1, wherein the anomaly metric values include a user device parameter anomaly metric value based on user device parameters associated with the first aggregate event data.

4. The method of claim 1, wherein the anomaly metric values include a downstream anomaly metric value that is based on a number of user device events that occur in the first aggregate event data.

5. The method of claim 4, wherein the downstream anomaly metric value is based on timings between events that occur in the first aggregate event data.

6. The method of claim 4, wherein the downstream anomaly metric value is based on what portions of users perform specific events that occur in the first aggregate event data.

7. The method of claim 1, further comprising generating individual user data objects that each store events for one of a plurality of users that generated the first aggregate event data, wherein the anomaly metric values include a user age metric value that is based on the age of the individual user data objects.

8. The method of claim 1, further comprising generating individual user data objects that each store events for one of a plurality of users that generated the first aggregate event data, wherein the anomaly metric values include a user activity metric value that is based on a number of users associated with greater than a threshold number of events within a defined period of time.

9. The method of claim 1, wherein the anomaly metric values include a statistical distribution metric value that is based on statistical distributions of activities across the first aggregate event data.

10. The method of claim 1, further comprising determining the plurality of anomaly metric values for the first sub-publisher based on one or more threshold values for each of the anomaly metric values.

11. A system comprising:
one or more storage devices configured to store:
first aggregate event data for a first sub-publisher, wherein the first aggregate event data indicates aggregate user activity across a plurality of applications associated with the first sub-publisher; and
second aggregate event data for a plurality of additional sub-publishers, wherein the second aggregate event data indicates aggregate user activity across a plurality of applications associated with the plurality of additional sub-publishers; and
one or more processing units that execute computer-readable instructions that cause the one or more processing units to:
determine a plurality of anomaly metric values for the first sub-publisher based on the first aggregate event data and the second aggregate event data;
determine an anomaly function value for the first sub-publisher based on the anomaly metric values for the first sub-publisher, wherein the anomaly function value indicates a likelihood that the first sub-publisher is associated with fraudulent user activity;
determine whether the user activity across the plurality of applications associated with the first sub-publisher is fraudulent based on the anomaly function value; and
notify a customer device of fraudulent activity in response to determining that the user activity associated with the first sub-publisher is fraudulent.

12. The system of claim 11, wherein the one or more processing units are configured to determine the anomaly metric values based on a comparison of the first aggregate event data and the second aggregate event data.

13. The system of claim 11, wherein the anomaly metric values include a user device parameter anomaly metric value based on user device parameters associated with the first aggregate event data.

14. The system of claim 11, wherein the anomaly metric values include a downstream anomaly metric value that is based on a number of user device events that occur in the first aggregate event data.

15. The system of claim 14, wherein the downstream anomaly metric value is based on timings between events that occur in the first aggregate event data.

16. The system of claim 14, wherein the downstream anomaly metric value is based on what portions of users perform specific events that occur in the first aggregate event data.

17. The system of claim 11, wherein the one or more processing units are configured to generate individual user data objects that each store events for one of a plurality of users that generated the first aggregate event data, wherein the anomaly metric values include a user age metric value that is based on the age of the individual user data objects.

18. The system of claim 11, wherein the one or more processing units are configured to generate individual user data objects that each store events for one of a plurality of users that generated the first aggregate event data, wherein the anomaly metric values include a user activity metric value that is based on a number of users associated with greater than a threshold number of events within a defined period of time.

19. The system of claim 11, wherein the anomaly metric values include a statistical distribution metric value that is based on statistical distributions of activities across the first aggregate event data.

20. The system of claim 11, wherein the one or more processing units are configured to determine the plurality of anomaly metric values for the first sub-publisher based on one or more threshold values for each of the anomaly metric values.
